(19) United States
(12) Patent Application Publication
(10) Pub. No.: US 2008/0310169 A1
(43) Pub. Date: Dec. 18, 2008

(54) DIFFUSIVE PLATE OF BACKLIGHT MODULE WITH POROUS DIFFUSIVE LAYER

(75) Inventors: Chih-Lung CHEN, Taichung Hsien (TW); Jui-Chang LIN, Taichung Hsien (TW); Chin-Feng CHANG, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Forhouse Cor4poration, Taichung Hsien (TW)

(21) Appl. No.: 11/764,475

(22) Filed: Jun. 18, 2007

(51) Int. Cl. F21V 11/00

(52) U.S. Cl. 362/311

(57) ABSTRACT

A backlight module includes a case, on which a reflecting film, lamps and a diffusive plate are provided in order. The diffusive plate includes a transparent substrate, on opposite of which a first diffusive layer and a second diffusive layer are provided. The first diffusive layer has a plurality of holes, each of which has a first refracting curved surface and a second refracting curved surface at opposite sides thereof along a thickness direction of the diffusive plate. The lamp radiates light, a part of which is reflected by the holes and a part of which travels through the holes and is refracted at the first refracting curved surface and the second refracting curved surface respectively.

### BACKGROUND OF THE INVENTION

1. Field of the Invention

The present invention relates generally to a backlight module, and more particularly to a backlight light module with a porous diffusive plate.

2. Description of the Related Art

A conventional liquid crystal display (LCD) includes a liquid crystal panel and a backlight module. The backlight module provides light to the liquid crystal panel to show predetermined image. Typically, the conventional backlight modules are classified into so called direct-light backlight module and so called edge-light backlight module.

The direct-light backlight module includes a case, on which a reflecting film, one or more cold cathode fluorescent lamps (CCFL) and a diffusive plate are provided in order. The diffusive plate diffuses the light of the CCFL to form a uniform light-emitting surface for the liquid crystal panel. The reflecting film reflects the light of CCFL to the diffusive plate for diffusion.

Typically, a conventional diffusive plate has one or more diffusive layer, in which diffusive particles are provided, such as PMMA system powder, PS system powder, calcium carbonate, silicon system powder, white carbon, silicon dioxide, titanium dioxide, zirconium dioxide, calcium dioxide, calcium carbonate, magnesium carbonate, barium sulfate, aluminum sulfate, calcium sulfate, ammonium sulfate, aluminum hydroxide, hollow glass beads, and not hollow glass beads etc. These particles have high reflecting property to reflect light in omni-directional. In other words, the only optical effect of the conventional diffusive plate is reflection, and the particles absorb light.

### SUMMARY OF THE INVENTION

The primary objective of the present invention is to provide a diffusive plate of a backlight module, which provides various optical effects.

According to the objective of the present invention, a diffusive plate of a backlight module includes a porous first diffusive layer. The first diffusive layer has a plurality of holes, each of which has a first refracting curved surface and a second refracting curved surface at opposite sides thereof along a thickness direction of the diffusive plate. The lamp of the backlight module radiates light to the first diffusive layer of the diffusive plate, a part of the light is reflected by the holes and a part of the light travels through the holes and is refracted at the first refracting portion and the second refracting portion respectively.

### BRIEF DESCRIPTION OF THE DRAWINGS

FIG. 1 is a sectional view of the backlight module of a preferred embodiment of the present invention;

FIG. 2 is a sectional view of the diffusive plate of the preferred embodiment of the present invention;

FIG. 3 is a sectional view from a bottom of the diffusive plate the preferred embodiment of the present invention, showing the holes;

FIG. 4 is a sectional view from a lateral side of the diffusive plate the preferred embodiment of the present invention, showing the holes;

FIG. 5 is a sketch diagram of the overlapped hole with the film therein;

FIG. 6 is a sketch diagram of the overlapped hole without the film;

FIG. 7 is a bottom view of the diffusive plate the preferred embodiment of the present invention, showing the broken holes on the surface; and

FIG. 8 is a second view of another diffusive plate of the preferred embodiment of the present invention.

### DETAILED DESCRIPTION OF THE INVENTION

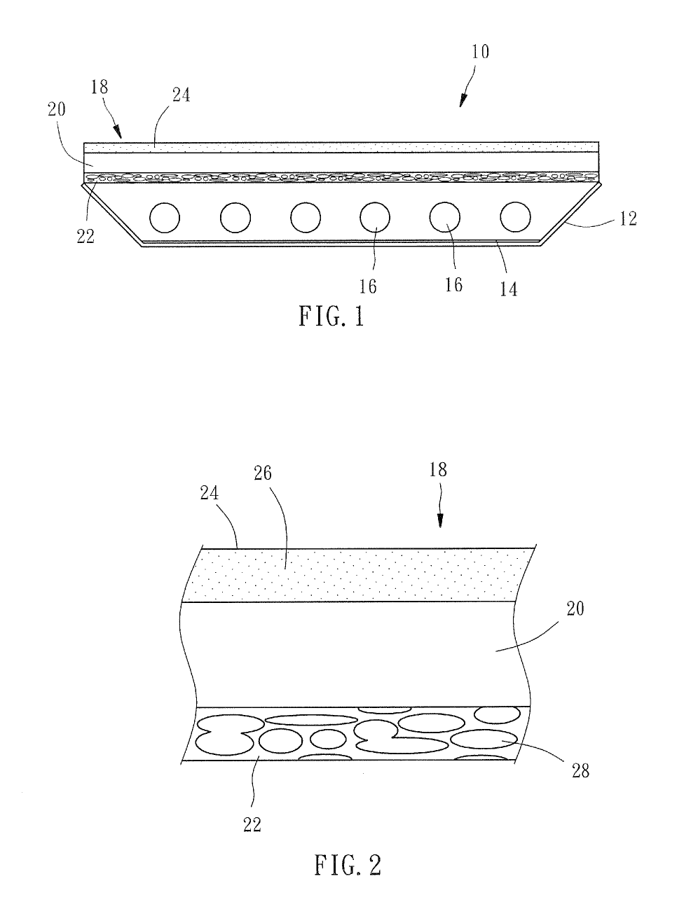

As shown in FIG. 1, a direct-light backlight module 10 for a liquid crystal display includes a case 12, on which a reflecting film 14, lamps 16 and a diffusive plate 18 are provided in order. The reflecting film 14 is attached on the case 12, and the diffusive plate 18 is mounted on a top of the case 12, and between reflecting film 14 and the diffusive plate 18 is the lamps.

As shown in FIG. 2, the diffusive plate 18 has a transparent substrate 20, on opposite sides of which a first diffusive layer 22 and a second diffusive layer 24 are provided respectively. The first diffusive layer 22 is on the side facing the lamps 16, and the second diffusive layer 24 is on the opposite side. The second diffusive layer 24, which is as same as the conventional diffusive layer, has diffusing particles 26 therein to perform omni-directional diffusion.

The first diffusive layer 22 may be made of polymethyl methacrylate (PMMA), polycarbonate (PC), cyclic olefins polymer (COP), MMA/styrene copolymer, or polystyrene with a porous structure. In other words, the first diffusive layer 22 has a plurality of holes 28 therein.

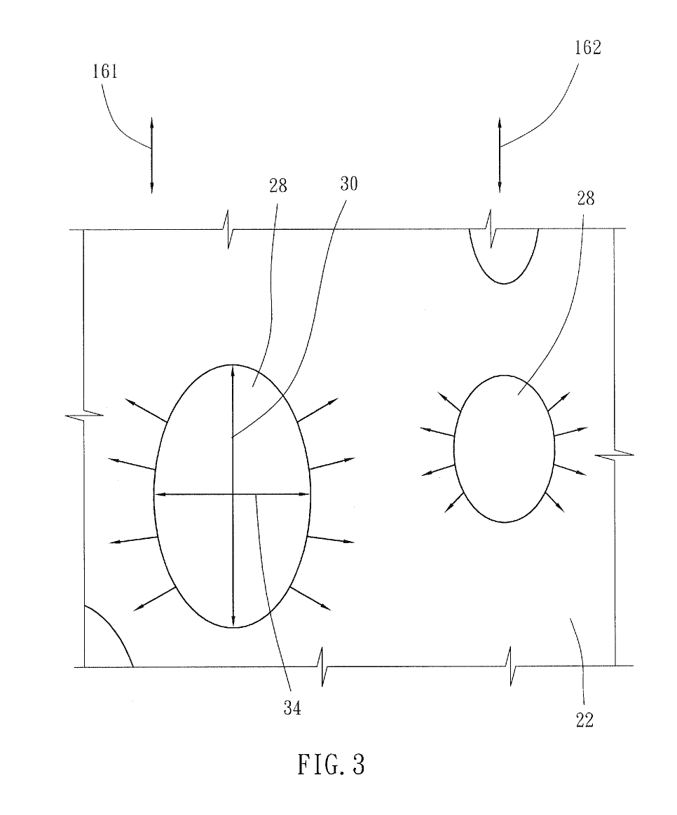

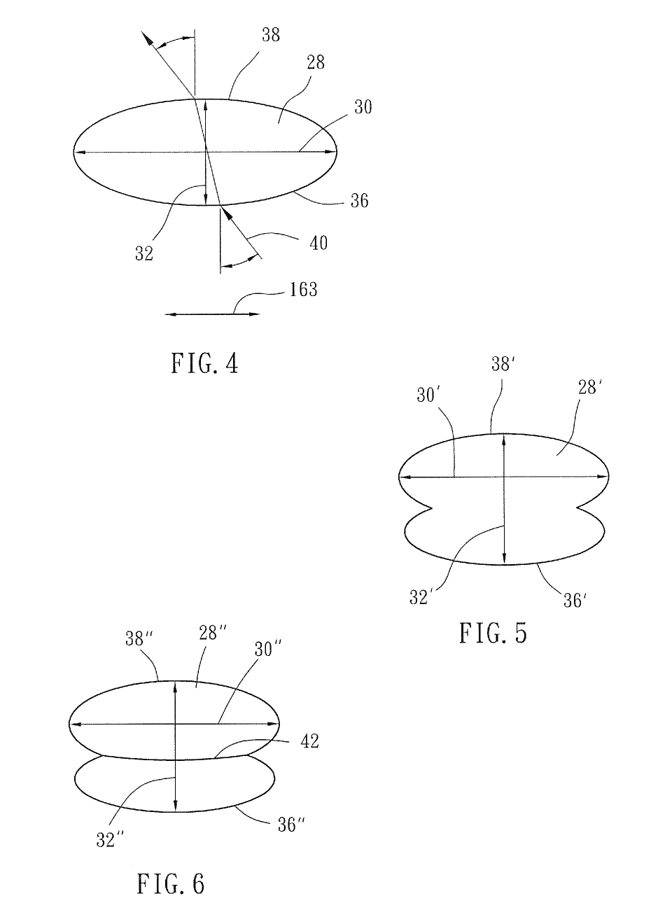

As shown in FIG. 3 and FIG. 4, each of the holes 28 of the first diffusive layer 22 substantially is elongated and flat elliptical holes with a long axis 30, a first short axis 32 and a second short axis 34. The long axis 30, the first short axis 32 and the second short axis 34 are perpendicular to each other, and the first short axis 32 is parallel to a thickness direction of the diffusive plate 18, and the long axis 30 and the second short axis 34 are parallel to a width direction and a length direction of the diffusive plate 18 respectively. The long axes 30 of the holes 28 are substantially parallel to each other and substantially parallel to the lamps 16. In one hole 18, the long axis 30 is longer than the first short axis 32 and the second short axis 34, and the second short axis 34 is longer than or equal to the first short axis 32. A horizontal sectional view of the hole 28, referring to FIG. 3, is an ellipse, and the hole 28, referring to FIG. 4, has a first refracting curved surface 36 and a second refracting curved surface 38 at opposite ends of the first short axis 32 respectively.

FIG. 3 is a horizontal sectional view of the first diffusive layer 22, and the lines labeled 161 and 162 represent the lamps 16. The long axes 30 of the holes 28 are parallel thereto. The lamps 16 radiate light to the holes 28 from the bottom of the drawing, and the major light is reflected by the holes 28 along the second short axes 34 substantially and minor light is reflected along the long axis 30, which means the holes 28 of the first diffusive layer 22 provides a directional diffusion to diffuse major light substantially along a direction perpendicular to the lamps 16.

FIG. 4 is a vertical sectional view of the first diffusive layer 22, and the line thereunder and labeled 163 represents the lamps 16. The lamp 16 radiates light to the bottom (the first refracting curved surface 36) of the hole 28 that the first refracting curved surface 36 acts as a convex lens. The light through the first refracting curved surface 36 will be refracted and is refracted again when the light travels through the second refracting curved surface 38, which acts as a concave lens. That is, the holes 28 in the first diffusive layer 22 reflect some of the light of the lamps 16 and allow some of the light through the holes 28 and reflected at the first refracting curved surface 36 and the second refracting curved surface 38. The optical effects of the first diffusive layer 22 include reflection and refraction.

As shown FIG. 5 and FIG. 6, there are some holes overlapped to form overlapped holes 28′ and 28″. Theses overlapped holes 28′ and 28″ are formed by two neighboring holes compressed, so that the overlapped holes 28′ and 28″ are are irregular because that we cannot control the compression of the holes. Some of the overlapped holes 28″ have a film 42 therein, referring to FIG. 6, and some of the overlapped holes 28′ don't have, referring to FIG. 5. Basically, each of the overlapped holes 28′ and 28″ still has a long axis 30′, 30″, a first short axis 32′, 32″ and a second short axis (not shown), and it has a first refracting curved surface 36′, 36″ and a second refracting curved surface 38′, 38″ at opposite ends of the first short axis 32′, 32″ for refraction. The overlapped hole 28″ with the film 42 therein has the film 42 to be a third refracting curved surface, which means the light through the overlapped hole 28″ will have three times of reflections.

Of course, there may be three or more holes overlapped, in which there may be two or more films.

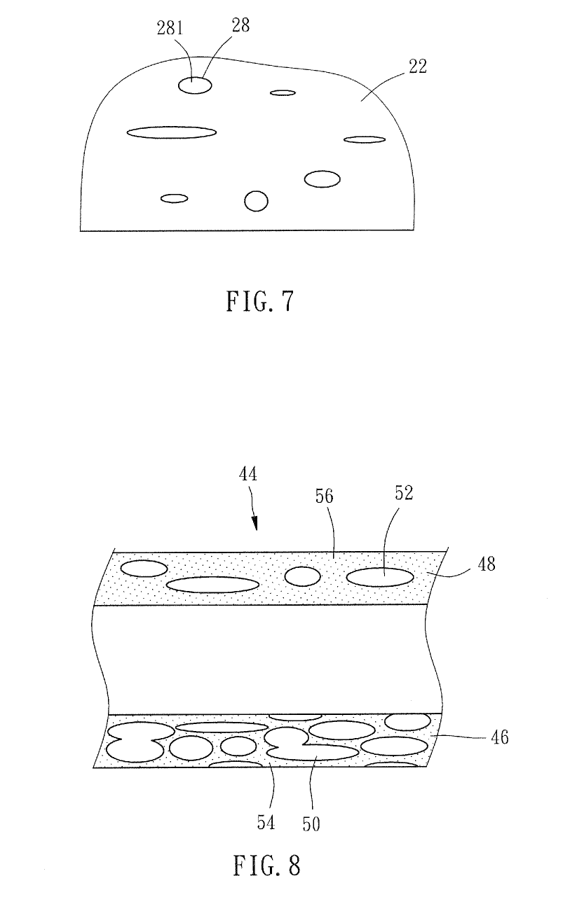

Some of the holes 28 are on the surfaces of the first diffusive layer 22, referring to FIG. 7, and the holes 28 are broken at the surface, which means these holes have openings 281 at the surfaces of the first diffusive layer 22.

In the diffusive plate 18 of the present invention, the light of the lamps 16 has directional diffusion in the first diffusive layer 22, and then has omni-directional diffusion in the second diffusive layer 24 that provides a better performance of diffusion.

FIG. 8 shows another diffusive plate 44 of the present invention including a first diffusive layer 46 and a second diffusive layer 48, both of which include holes 50, 52 and diffusive particles 54, 56 therein. The difference of the first diffusive layer 46 and the second diffusive layer 48 is that the first diffusive layer 46, facing the lamps, has a high concentration of the holes 50 and a low concentration of the diffusive particles 54, and the second diffusive layer 48 has a low concentration of the holes 52 and a high concentration of the diffusive particles 56.

In practice, there may be one or three more diffusive layer(s), or the holes are distributed in the entire diffusive plate. The sizes and distribution of the holes are selected by the designer to meet the requirement.

Now, we provide a method for making the diffusive plate 18 of the present invention.

1. Material Preparation:

The main materials of the transparent substrate 20, the first diffusive layer 22 and the second diffusive layer 24 are selected from the group of polymethyl methacrylate (PMMA), polycarbonate (PC), cyclic olefins polymer (COP), MMA/styrene copolymer, or polystyrene, or other relative material. In the present invention, we choose PMMA as a first material to make the substrate 20 and PMMA mixed with diffusive particles as a third material to make the second diffusive layer 24. The first material and the second material are as same as the prior art, so we do not describe the detail here.

A second material of making the first diffusive layer 22 is PMMA mixed with a foaming agent. A mixing process is performed to well mix the foaming agent in PMMA, and the temperature when performs the mixing process must be lower than a foaming temperature of the foaming agent. That is, the second material has unfoamed foaming agent therein.

When we make the diffusive plate 44 of the present invention, materials making the diffusive layers 46, 48 are PMMA well mixed with diffusive particles and a foaming agent, and the other processes are the same.

For a ratio of PMMA, the diffusive particles and the foaming agent, which effects the distribution of the holes and the diffusive particles, is adjustable by the manufacturers according to the requirements.

2. Co-Extrusion Process:

The first material, the second material and the third material are put in a first extruder, a second extruder and a third extruder respectively to melt the materials and extrude them to a die to form a three-layer stack. The operations of the first and third extruders are as same as the prior art, so we only describe how to operate the second extruder hereunder:

The second extruder heats the second material to the foaming temperature, but the foaming agent in the second material still is unformed because of the high pressure in the extruder. The foaming agent foams immediately when it is out of the extruder to form a plurality of gas balls in the second material.

The conventional extruder is equipped with an air-extracting apparatus. In above procedure, the air-extracting apparatus of the second extruder is closed. It may start the air-extracting apparatus also, so that the foaming agent will foam in the extruder, and the power of the air-extracting apparatus is adjusted to control the concentrations of the gas balls. It is noted that it must add more foaming agent in the second material when the air-extracting apparatus is started to make up for the gas extracted by the air-extracting apparatus.

For a further discussion, there are two ways of making the diffusive layer with various concentrations of holes, which are preparing two materials with different concentrations of foaming agents and closing the air-extracting apparatus and preparing only one material and controlling the power of the air-extracting apparatus.

3. Chilling and Rolling Process:

The three-layer stack is sent to a roller for chilling and rolling. When the rollers press the three-layer stack, the gas balls in the second material are compressed to form the elongated and flat holes 28 as shown in FIG. 3.

4. Cutting Process:

After rolling process, the rolled three-layer stack is cut to be divided into a plurality of diffusive plates as shown in FIG. 2. The first material forms the transparent substrate 20, the second material forms the first diffusive layer 22, which has a plurality of the elongated and flat holes 28 therein, and the third material forms the second diffusive layer 24, which has diffusive particles.

A method of making the diffusive plate 44 as shown in FIG. 8 basically is as same as the above processes, except that the second and third materials are added with different concentrations of foaming agents and diffusive particles.

Another method of making the first diffusive layer 46 and the second diffusive layer 48 of the diffusive plate 44 includes preparing one material mixed with a foaming agent and diffusive particles and sending it to two extruders. The air-extracting apparatus are started and adjusted to have desired power that these two extruders may provides two layers with different concentrations of gas balls therein.

In conclusion, the diffusive plate of the present invention provides the holes therein to perform directional reflections and refractions. The various optical effects that the diffusive plate of the present invention provides will perform a better diffusion of light.

The description above is a few preferred embodiments of the present invention and the equivalence of the present invention is still in the scope of the claim of the present invention.

What is claimed is:

1. A diffusive plate of a backlight module, wherein the backlight module includes a case, on which at least a lamp and the diffusive plate are provided in order, comprising a first diffusive layer, which has a porous structure, having holes, each of which has a first refracting curved surface and a second refracting curved surface at opposite sides thereof along a thickness direction of the diffusive plate, wherein the lamp radiates light to the first diffusive layer, and a part of the light is reflected by the holes and a part of the light travels through the holes and is refracted at the first refracting curved surface and the second refracting curved surface respectively.

2. The diffusive plate of the backlight module as defined in claim 1, wherein each of the holes in the first diffusive layer includes a long axis substantially parallel to the lamp, a first short axis with the refracting curved surface and the second refracting curved surface are on opposite ends thereof and a second short axis perpendicular to each other, and of the first short axis respectively.

3. The diffusive plate of the backlight module as defined in claim 1, wherein the first diffusive layer further includes diffusive particles therein.

4. The diffusive plate of the backlight module as defined in claim 1, wherein the first diffusive layer includes at least two of the holes overlapped to form an overlapped hole.

5. The diffusive plate of the backlight module as defined in claim 4, wherein the overlapped hole has a film therein to form a third refracting curved surface for refracting the light through the overlapped hole.

6. The diffusive plate of the backlight module as defined in claim 1, wherein some of the holes have openings on surfaces of the first diffusive layer.

7. The diffusive plate of the backlight module as defined in claim 1, further comprising a second diffusive layer on a side opposite to the first diffusive layer.

8. The diffusive plate of the backlight module as defined in claim 7, wherein the second diffusive layer includes diffusive particles therein.

9. The diffusive plate of the backlight module as defined in claim 7, wherein the first diffusive layer further includes diffusive particles therein.

10. The diffusive plate of the backlight module as defined in claim 7, wherein the second diffusive layer has a porous structure having a plurality of holes, each of which has a first refracting curved surface and a second refracting curved surface at opposite sides thereof along a thickness direction of the diffusive plate, wherein the lamp radiates light, a part of which is reflected by the holes and a part of which travels through the holes and is refracted at the first refracting curved surface and the second refracting curved surface respectively.

11. The diffusive plate of the backlight module as defined in claim 10, wherein the second diffusive layer further includes diffusive particles therein.

12. The diffusive plate of the backlight module as defined in claim 10, wherein the second diffusive layer includes at least two of the holes overlapped to form an overlapped hole.

13. The diffusive plate of the backlight module as defined in claim 12, wherein the overlapped hole has a film therein to form a third refracting curved surface for refracting the light through the overlapped hole.

14. The diffusive plate of the backlight module as defined in claim 10, wherein some of the holes have openings on surfaces of the second diffusive layer.
